(19) United States
(12) Patent Application Publication
(10) Pub. No.: US 2014/0043787 A1
(43) Pub. Date: Feb. 13, 2014

(54) LAMP TO ENHANCE PHOTOSYNTHESIS AND PEST CONTROL AND AN OXYGEN GENERATOR HAVING THE SAME

(71) Applicant: WEI-KUNG WANG, Taipei (TW)

(72) Inventor: WEI-KUNG WANG, Taipei (TW)

(21) Appl. No.: 13/569,253

(22) Filed: Aug. 8, 2012

(51) Int. Cl. F21V 9/16

(52) U.S. Cl. 362/84

(57) ABSTRACT

A lamp to enhance photosynthesis and pest control includes an light emitting diode (LED) light source having a emission wavelength ranging from 400 nm to 460 nm and the LED light source generating light and a first fluorescent material exposed to the light. The present invention also provides an oxygen generator including the lamp to enhance photosynthesis and pest control according to the present invention and a plant.

### BACKGROUND OF THE INVENTION

1. Field of the Invention

The present invention relates to technique for enhancing photosynthesis of a plant to increase the production of oxygen, facilitate and modulate plant growth, and particularly to technique for enhancing photosynthesis under a darkened environment or an environment having insufficient sunlight.

2. Description of the Prior Arts

Plants need light to grow and flourish. For many years, to replace sunlight, researchers have developed methods for facilitating plant growth by using artificial light source. Currently, the artificial light sources for facilitating plant growth include halogen light, incandescent light and light emitted from light emitting diode (LED) lamps. Halogen light and incandescent light provide white light source and have continuous spectra. However, the main drawbacks of the halogen light and incandescent light include production of high thermal energy, short life span, and high power consumption. As for the LED lamps, the LED lamps currently are combination of blue LEDs (450 nm) and red LEDs (660 nm) to facilitate plant growth. However, the main drawback of the LEDs lamps is high cost.

Besides, plants produce oxygen through photosynthesis. One of the apparatus relates to providing oxygen is oxygen concentrator, which is already sold on the market. However, the oxygen concentrator only concentrates oxygen in a small area by depleting oxygen in other area, and the oxygen concentrator cannot reduce the amount of CO₂ of an environment. Furthermore, the oxygen concentrator is not power-saving.

To overcome the shortcomings, the present invention provides a lamp to enhance photosynthesis and pest control and an oxygen generator having the same to mitigate or obviate the aforementioned problems. The present invention also provides an oxygen generator having the lamp to enhance photosynthesis and pest control to increase the amount of oxygen of an environment.

### SUMMARY OF THE INVENTION

Given the aforesaid drawbacks of the prior art such as high cost, production of high thermal energy, short life span, and high power consumption, the main objective of the present invention is to provide a lamp to enhance photosynthesis and pest control, particularly, a lamp to enhance photosynthesis and pest control that is low-cost, power-saving, avoids production of high thermal energy, is highly efficient, prolongs and facilitates plant growth, and modulates the photosynthesis of a plant in order to control blossom and bearing fruit. Moreover, the present invention provides an oxygen generator having the lamp to enhance photosynthesis and pest control that is capable of increasing the amount of oxygen in an environment.

Accordingly, the lamp to enhance photosynthesis and pest control in accordance with the present invention comprises:

a light emitting diode (LED) light source having an emission wavelength ranging from 400 nm to 460 nm and the LED light source generating light; and

a first fluorescent material exposed to the light to generate a first emission light.

Preferably, the lamp facilitates plant growth.

Preferably, the lamp controls plant growth.

Preferably, the lamp to enhance photosynthesis and pest control comprises a reflecting plate being in a position to be exposed to the light generated by the LED light source, and the reflecting plate has an inner surface and an outer surface that is opposite to the inner surface, and the first fluorescent material is coated on the inner surface of the reflecting plate, and an first emission light ranges from 620 nm to 680 nm is emitted from the first fluorescent material after the first fluorescent material is excited by the light generated by the LED light source.

Preferably, the first fluorescent material is selected from a group consisting of fura red and CaS.

Preferably, the lamp to enhance photosynthesis and pest control comprises a sheet and a glue with a second fluorescent material, wherein the sheet is deposited at a position away from the reflecting plate and is exposed to light generated by the LED light source and the glue with a second fluorescent material is applied to the sheet, and an second emission light ranges from 550 nm to 590 nm is emitted from the second fluorescent material after the second fluorescent material is excited by the LED light source.

Preferably, the second fluorescent material is ND:YAG (neodymium doped yttrium aluminum garnet).

Preferably, the lamp to enhance photosynthesis and pest control comprises an automatic switch connected to the LED light source.

Preferably, the lamp is for use as an indicator of the health status of the plant.

Accordingly, an oxygen generator in accordance with the present invention comprises:

a light emitting diode (LED) light source having an emission wavelength ranging from 400 nm to 460 nm and the LED light source generating light;

a first fluorescent material exposed to the light; and

a plant to be exposed to the light generated by the LED light source.

Preferably, the oxygen generator comprises one reflecting plate being in a position to be exposed to the light generated by the LED light source and adjacent to the plant, and the reflecting plate has an inner surface and an outer surface that is opposite to the inner surface, and the first fluorescent material is coated on a surface of the reflecting plate, and an first emission light ranges from 620 nm to 680 nm is emitted from the first fluorescent material after the first fluorescent material is excited by the LED light source to illuminate the plant.

Preferably, the first fluorescent material is selected from a group consisting of fura red and CaS.

Preferably, the oxygen generator comprises a sheet and a glue with a second fluorescent material, wherein the sheet is away from the reflecting plate and is exposed to light generated by the LED light source, and the glue with a second fluorescent material is applied to the sheet, and an second emission light ranges from 550 nm to 590 nm is emitted from the second fluorescent material after the second fluorescent material is excited by the LED light source.

Preferably, the second fluorescent material is ND:YAG (neodymium doped yttrium aluminum garnet).

Preferably, the oxygen generator comprises an automatic switch connected to the LED light source.

Preferably, the reflecting plate reflects light and is also for use as decoration.

The present invention provides a lamp to enhance photosynthesis and pest control. Compared to halogen lamps and incandescent lamps, the lamp for enhancing photosynthesis in accordance with the present invention uses an LED light source having an emission wavelength ranging from 400 nm to 460 nm to facilitate plant growth and thus the present invention is power-saving, avoids production of high thermal energy and has high efficiency. Compared to the conventional LED lamps, the lamp in accordance with the present invention uses the LED light source having only an emission wavelength ranging from 400 nm to 460 nm to reach the purpose of facilitating plant growth and thus is cost effective. Besides, the lamp has the first fluorescent material being exposed to the light in order to generate different wavelengths of lights. Besides, the lamp for enhancing photosynthesis in accordance with the present uses a first fluorescent material exposed to the light to convert the light generated by the LED light source to a light with different wavelengths.

Moreover, the lamp in accordance with the present invention has a reflecting plate to reflect the light having a wavelength between 400 nm and 460 nm, which is emitted from the LED light source, and the lamp in accordance with the present invention can efficiently convert the light to a light having a longer wavelength by the reflecting plate having the first fluorescent material coated on a surface of the reflecting plate. Hence, the lamp in accordance with the present invention has the LED light source having merely an emission wavelength ranging from 400 nm to 460 nm, but provides lights having different wavelengths to facilitate plant growth.

Furthermore, the lamp in accordance with the present invention has the automatic switch to turn on or turn off the lamp for enhancing photosynthesis at designated times and thus is convenient, power saving and environmental-friendly.

The present invention also provides an oxygen generator having the lamp to enhance photosynthesis and pest control to expose the plant to the light generated by the LED light source and the first emission light emitted from the first fluorescent material increasing the efficiency of photosynthesis of the plant and thus increasing the production of oxygen, which is beneficial to the environment. As a result, the oxygen generator can be regarded as a medical device, and the oxygen generator functions far better than an oxygen concentrator. The oxygen generator in accordance with the present invention, which not only generates oxygen but also reduces the amount of CO₂ of an environment due to the effective photosynthesis.

Furthermore, the oxygen generator comprises the first fluorescent material, and thus under a darkened environment, the oxygen generator having the lamp is colorful, beautiful and is shining in the darkened environment and thus the oxygen generator having the lamp can be used as an interior decoration, and also increases consumers' purchasing motives.

Other objectives, advantages and novel features of the invention will become more apparent from the following detailed description when taken in conjunction with the accompanying drawings.

### BRIEF DESCRIPTION OF THE DRAWINGS

FIG. 1 is a diagram of absorbance versus wavelength of light for driving photosynthesis;

FIG. 2 is a perspective view of a first embodiment of a lamp to enhance photosynthesis and pest control and a first embodiment of an oxygen generator having the same in accordance with the present invention; and

FIG. 3 is a perspective view of a second embodiment of a lamp to enhance photosynthesis and pest control and a second embodiment of oxygen generator having the same in accordance with the present invention.

### DETAILED DESCRIPTION OF THE PREFERRED EMBODIMENTS

The present invention provides a lamp to enhance photosynthesis and pest control and an oxygen generator having the same.

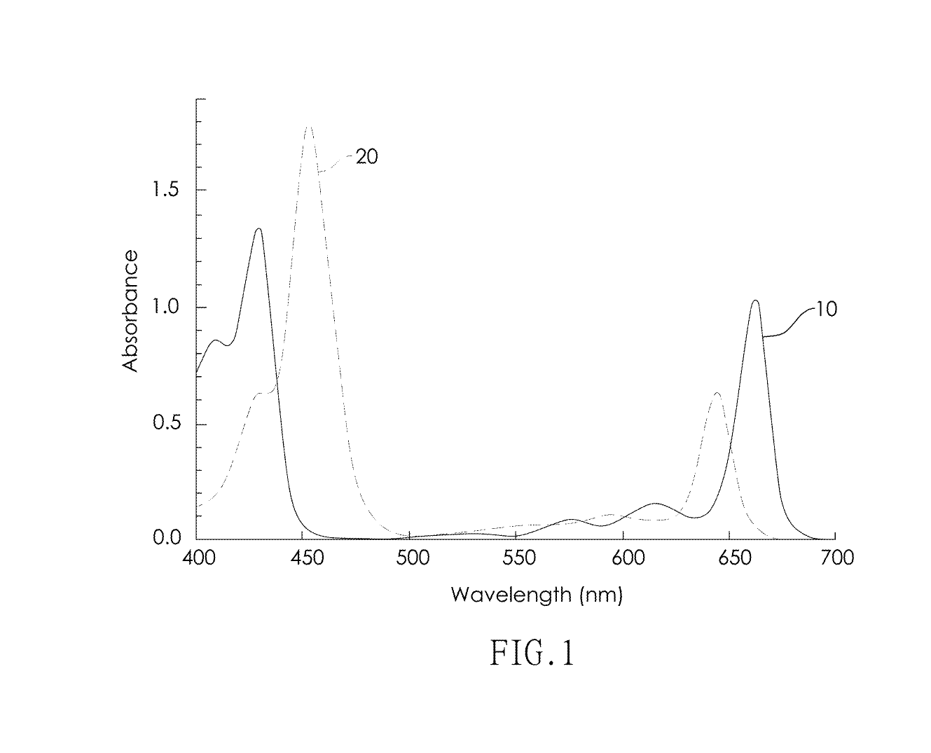

With reference to FIG. 1, the wavelengths of lights for driving photosynthesis of chlorophyll a 10 and chlorophyll b 20 range from 400 nm to 500 nm and from 600 nm to 700 nm. An LED light source at an emission wavelength within the range of the absorption wavelength of chlorophyll a and chlorophyll b is selected to replace the incandescent light. Moreover, the LED light source at the emission wavelength ranging from 400 nm to 460 nm is selected to replace the conventional LED lamps having two different emission wavelengths.

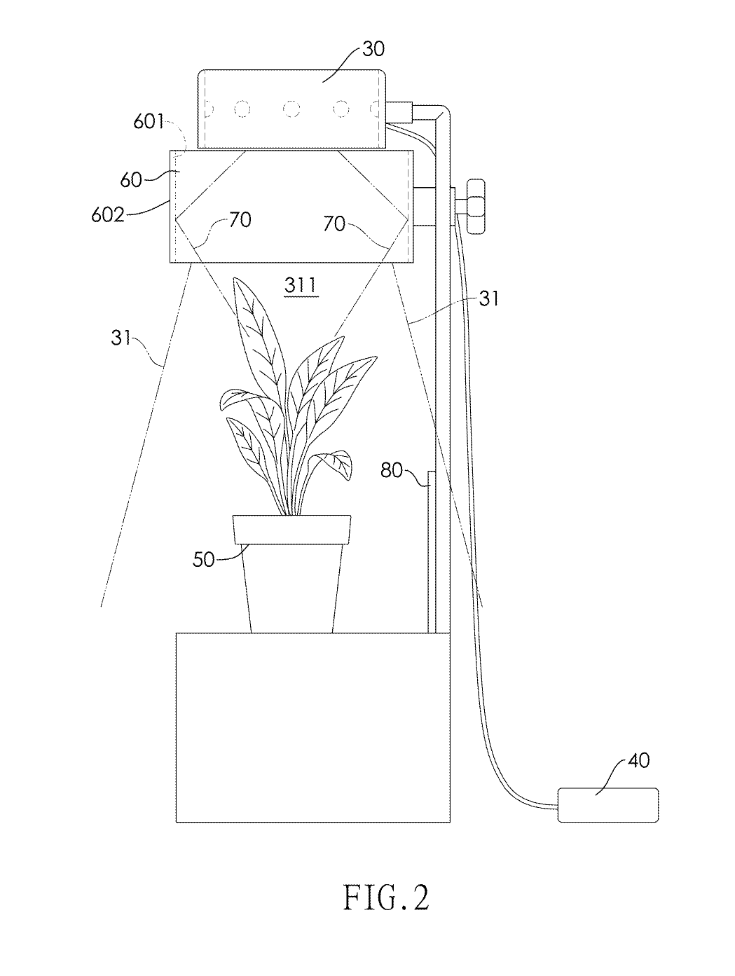

With reference to FIG. 2, a first embodiment of a lamp to enhance photosynthesis and pest control in accordance with the present invention comprises an LED light source 30, a power supply 40, a reflecting plate 60, a first fluorescent material, a sheet 80 and a glue with a second fluorescent material. The LED light source 30 has an emission wavelength ranging from 400 nm to 460 nm and the LED light source 30 generates light 31, wherein the light 31 provides an illumination area 311. The LED light source 30 is mounted on an inner surface of a hollow cylinder. The power supply 40 is connected to the LED light source 30 and the power supply 40 is a solar cell in order to make the lamp for enhancing photosynthesis even for saving more power. The reflecting plate 60 is in a position to be exposed to the light 31 generated by the LED light source 30. The reflecting plate 60 is a hollow cylinder and has an inner surface 601 and an outer surface 602 being opposite to the inner surface 601. The first fluorescent material is coated to form a pattern on the inner surface 601 of the reflecting plate 60. The first fluorescent material is fura red.

The light 31 of the LED light source 30 illuminates the inner surface 601 of the reflecting plate 60 and thus the light 31 generated by the LED light source 30 illuminates the first fluorescent material to be an excitation light. After the energy of the excitation light is absorbed by the first fluorescent material, namely, after the fluorescent material is exited by the LED light source 30, a first emission light 70 is emitted from the first fluorescent material. In accordance with the present invention, different kinds of first fluorescent materials material can be coated on the inner surface 601 of the reflecting plate 60 to form different patterns. The sheet 80 is deposited at a position away from the reflecting plate 60 and is deposited within the illumination area 311. The glue with a second fluorescent material is applied onto the sheet 80; thus the second fluorescent material is also deposited within the illumination area 311. The second fluorescent material is ND:YAG (neodymium doped yttrium aluminum garnet), and a mixed particle size of a few hundred μm of Nd:YAG particles is used in the present embodiment in order to convert the light 31 generated by the LED light source 30 to a light with a wavelength between 550 nm to 590 nm, which is a yellowish light and will attract insects, and particularly the insects that carries viruses. Thus, a second emission light at a wavelength ranging from 550 nm to 590 nm is emitted from the second fluorescent material after the second fluorescent material is excited by the LED light source. The wavelength of the second emission light will depend on the particle size of the Nd:YAG. The larger the particle size of Nd:YAG, the longer the wavelength of the second emission light. As we know, insects are attracted to the near-UV light, which is used to trap insects. Because people cannot see the near-UV light, so it is known as a dark trap. The LED light source 30 of the present invention is at a wavelength about 400 nm to 460 nm, which is not a near-UV light. As a result, the insects will try to avoid the area inside the reflecting plate 60 because the wavelength of the first emission light 70 is 620 nm to 680 nm, which is not a near-UV light. In conclusion, the area inside the reflecting plate 60 repulses the insects. However, the sheet 80, which is deposited at a position away from the reflecting plate and is within the illumination area 311 and has the glue with the second fluorescent material on it, will attract insects to immobilize the insects and kill them. As a result, the lamp to enhance photosynthesis and pest control will further help the pest control. Besides, under a darkened environment, the lamp to enhance photosynthesis and pest control in accordance with the present invention is deposited near a plant and is turned on. Thus the plant is exposed to the light generated by the LED light source. The health status of the plant can be determined by using an oxygen index to measure the amount of oxygen released by the plant. Therefore, the lamp is for use as an indicator of the health status of the plant.

With reference to FIG. 2, a first embodiment of an oxygen generator in accordance with the present invention comprises the lamp to enhance photosynthesis and pest control mentioned above and a plant 50. The reflecting plate 60 is between the LED light source 30 and the plant 50. The plant 50 is below the LED light source 30 and deposited within the illumination area 311 of the LED light source 30; thus, the plant 50 is exposed to the light 31 generated by the LED light source 30 and exposed to the first emission light 70 emitted from the first fluorescent material. Besides, under an environment having sufficient sunlight, the sunlight still passes through the hollow cylinder having the LED light source 30 to illuminate the plant 50, and the oxygen generator having the lamp produces oxygen. Under an environment having insufficient sunlight, the light 31 generated by the LED light source 30 illuminates the plant 50, and thus the oxygen generator having the lamp produces oxygen. Moreover, in addition to the sunlight and the light 31 generated by the LED light source 30, the first emission light 70 emitted from the first fluorescent material illuminates the plant 50, and the oxygen generator further increases the production of oxygen. The first emission light 70 emitted from the first fluorescent material present different colors based on the different kinds of first fluorescent materials, and the patterns formed on the inner surface 601 of the reflecting plate 60 shine under a darkened environment. Moreover, the second emission light emitted from the second fluorescent material present different color from the first emission light 70, so the oxygen generator having the lamp is colorful, beautiful and shines in the darkened environment; thus, the oxygen generator having the lamp can be used as an interior decoration. In addition, the oxygen generator can be used indoors to increase the amount of oxygen of the environment. In general, the amount of oxygen of a normal environment is about 21%. The oxygen generator in accordance with the present invention increases the amount of oxygen, and the decreasing degree depends on the volume of the environment.

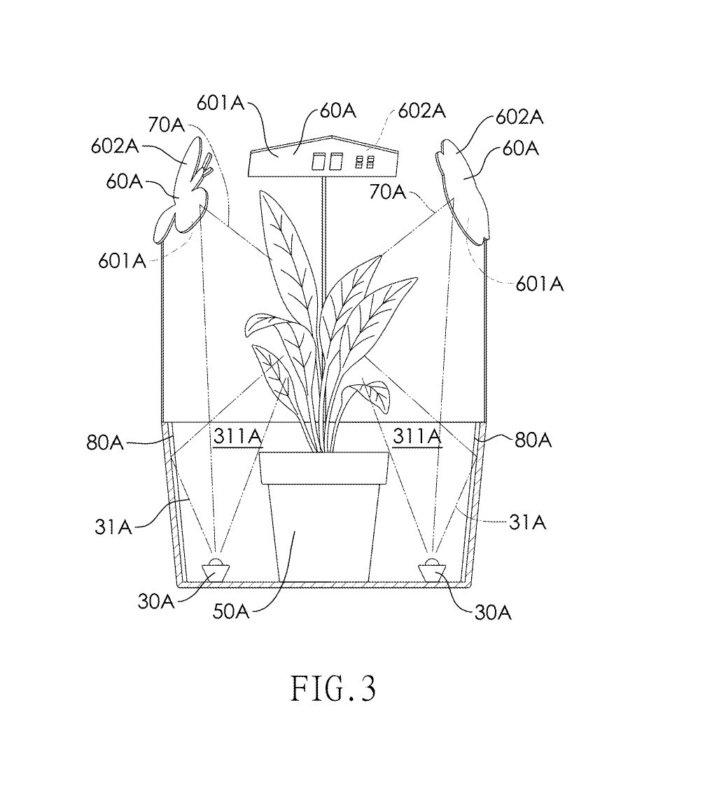

With reference to FIG. 3, a second embodiment of a lamp to enhance photosynthesis and pest control in accordance with the present invention comprises two sets of LED light source 30A, three reflecting plates 60A and two sheets 80A. The two sets of LED light source 30A are opposite to the three reflecting plates 60A.

Each of the reflecting plates 60A is in a different shape, including flower shape, butterfly shape and house shape, so the reflecting plates 60A increase aesthetic appeal of the lamp for enhancing photosynthesis. Each of the reflecting plates 60A has an inner surface 601A near the plant and an outer surface 602 A opposite to the inner surface 601A. The first fluorescent material is coated and formed a pattern on each inner surface 601A of the reflecting plates 60A. The light 31A generated by the two sets of LED light source 30A illuminates each inner surface 601A of the reflecting plates 60A and thus the light 31A generated by the two sets of LED light source 30 illuminates the first fluorescent material to be an excitation light. After the energy of the excitation light is absorbed by the first fluorescent material; namely, after the first fluorescent material is exited by the LED light source, 30A an first emission light 70A is emitted from the first fluorescent material. The sheets 80A is deposited at a position away from the reflecting plate 60 and are opposite to each other, and is deposited within the illumination area 311. Each sheets 80A has glue with ND:YAG on its surface.

With reference to FIG. 3, a second embodiment of an oxygen generator in accordance with the present invention comprises the lamp to enhance photosynthesis and pest control mentioned above and a plant 50A. The two sets of LED light source 30A are adjacent to the plant 50A and near the downside of the plant 50A, and the plant 50A is between the two sets of LED light source. The light 31A emitted from the two sets of LED light source 30A is in a direction from downside to upside to illuminate the plant 50A. The reflecting plates 60A are arranged to surround the plant 50A. The plant 50A is partially within the illumination area 311A of the two sets of LED light source 30A and is exposed to the first emission light 70 emitted from the first fluorescent material.

A third embodiment of a lamp to enhance photosynthesis and pest control in accordance with the present invention further comprises an automatic switch, The automatic switch is connected to the multiple LEDs and to the power supply. A third embodiment of an oxygen generator in accordance with the present invention comprises the lamp to enhance photosynthesis and pest control mentioned above and a plant. When an environment having insufficient sunlight, the automatic switch is controlled by a micro-computer program in order to illuminate the plant at designated times and thus the oxygen generator having the lamp can generate oxygen continuously under a darkened environment.

A forth embodiment of a lamp to enhance photosynthesis and pest control in accordance with the present invention further comprises pheromone being mixed with the glue with the second fluorescent material and being applied on the sheet in order to increase the attraction to specific insects.

In an experiment, a plant of the oxygen generator of the present invention was still alive after six months. However, another plant without using the lamp to enhance photosynthesis and pest control died within three weeks, which indicated that the lamp to enhance photosynthesis and pest control of the present invention truly facilitates the growth and the photosynthesis of a plant and thus controls blossoming and bearing fruit.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A lamp to enhance photosynthesis and pest control comprising:
a light emitting diode (LED) light source having an emission wavelength ranging from 400 nm to 460 nm and the LED light source generating light; and
a first fluorescent material exposed to the light to generate a first emission light.

2. The lamp to enhance photosynthesis and pest control according to claim 1, which facilitates plant growth.

3. The lamp to enhance photosynthesis and pest control according to claim 1, which controls plant growth.

4. The lamp to enhance photosynthesis and pest control according to claim 1, which comprises a reflecting plate being in a position to be exposed to the light generated by the LED light source, wherein the reflecting plate has an inner surface and an outer surface that is opposite to the inner surface, and the first fluorescent material is coated on the inner surface of the reflecting plate, and an first emission light ranges from 620 nm to 680 nm is emitted from the first fluorescent material after the first fluorescent material is excited by the light generated by the LED light source.

5. The lamp to enhance photosynthesis and pest control according to claim 4, wherein the first fluorescent material is selected from a group consisting of fura red and CaS.

6. The lamp to enhance photosynthesis and pest control according to claim 4, which comprises a sheet and a glue with a second fluorescent material, wherein the sheet is deposited at a position away from the reflecting plate and is exposed to light generated by the LED light source, and the glue with the second fluorescent material is applied to the sheet, and an second emission light ranges from 550 nm to 590 nm is emitted from the second fluorescent material after the second fluorescent material is excited by the LED light source.

7. The lamp to enhance photosynthesis and pest control according to claim 6, wherein the second fluorescent material is ND:YAG (neodymium doped yttrium aluminum garnet).

8. The lamp to enhance photosynthesis and pest control according to claim 1, which comprises an automatic switch connected to the LED light source.

9. The lamp to enhance photosynthesis and pest control according to claim 1, which is for use as an indicator of the health status of the plant.

10. An oxygen generator comprising:
an LED light source having an emission wavelength ranging from 400 nm to 460 nm and the LED light source generating light;
a first fluorescent material exposed to the light to generate a first emission light; and
a plant to be exposed to the light generated by the LED light source.

11. The oxygen generator according to claim 10, which comprises one reflecting plate being in a position to be exposed to the light generated by the LED light source and adjacent to the plant, wherein the reflecting plate has an inner surface and an outer surface that is opposite to the inner surface, and the first fluorescent material is coated on a surface of the reflecting plate, and an first emission light ranges from 620 nm to 680 nm is emitted from the first fluorescent material after the first fluorescent material is excited by the LED light source to illuminate the plant.

12. The oxygen generator according to claim 11, wherein the first fluorescent material is selected from a group consisting of fura red and CaS.

13. The oxygen generator according to claim 11, which comprises a sheet and a glue with a second fluorescent material, wherein the sheet is deposited at a position away from the reflecting plate and is exposed to light generated by the LED light source, and the glue with the second fluorescent material is applied to the sheet, and an second emission light ranges from 550 nm to 590 nm is emitted from the second fluorescent material after the second fluorescent material is excited by the LED light source.

14. The oxygen generator according to claim 13, wherein the second fluorescent material is ND:YAG (neodymium doped yttrium aluminum garnet).

15. The oxygen generator according to claim 10, which comprises an automatic switch connected to the LED light source.

16. The oxygen generator according to claim 11, wherein the reflecting plate reflects light and is also for use as decoration.
